(19) United States
(12) Patent Application Publication
(10) Pub. No.: US 2026/0008979 A1
(43) Pub. Date: Jan. 8, 2026

(54) CLEANING SOLUTION AND INK SET

(71) Applicant: KYOCERA DOCUMENT SOLUTIONS INC., OSAKA (JP)

(72) Inventor: MOTONOBU SUGIMOTO, OSAKA (JP)

(21) Appl. No.: 19/257,485

(22) Filed: Jul. 2, 2025

(30) Foreign Application Priority Data
Jul. 3, 2024 (JP) 2024-107782

(51) Int. Cl. C11D 3/37; C09D 11/54; C11D 1/66; C11D 3/43

(52) U.S. Cl. CPC C11D 3/3703; C09D 11/54; C11D 1/66; C11D 3/43

(57) ABSTRACT

According to an embodiment of the present disclosure, there is provided a cleaning solution, including: a water-soluble organic solvent; a polyacrylic acid salt; an acrylic acid-maleic acid copolymer salt; water; and a surfactant, a mass ratio of the acrylic acid-maleic acid copolymer salt to the polyacrylic acid salt being 1 or more and 4 or less.

### CROSS-REFERENCE TO RELATED PATENT APPLICATION

This application claims the benefit of Japanese Priority Patent Application JP 2024-107782 filed Jul. 3, 2024, the entire contents of which are incorporated herein by reference.

### FIELD OF THE DISCLOSURE

The present disclosure relates to a cleaning solution and an ink set.

### BACKGROUND OF THE DISCLOSURE

In the past, inks containing binder resins, which exhibit excellent fixability to recording media with low ink absorption (low absorption media), have been known. Such inks containing binder resins strongly adhere to a substrate upon drying. For this reason, in the case where the above ink adheres to a nozzle plate of an inkjet head and dries, it is difficult to remove the dried product of the ink.

Various cleaning solutions for removing the dried ink formed by drying on the nozzle plate or the like have been proposed. For example, Japanese Patent No. 6780618 discloses a cleaning solution for inkjet recording heads, which contains a deliquescent agent, 2-pyrrolidone as an organic solvent, a surfactant, and the like.

### SUMMARY OF THE DISCLOSURE

A cleaning solution according to an embodiment of the present disclosure includes: a water-soluble organic solvent; a polyacrylic acid salt; an acrylic acid-maleic acid copolymer salt; water; and a surfactant.

A mass ratio of the acrylic acid-maleic acid copolymer salt to the polyacrylic acid salt is 1 or more and 4 or less.

The cleaning solution may have a static surface tension of less than 30 mN/m.

The polyacrylic acid salt may have a molecular weight of 4000 or less.

The polyacrylic acid salt may be selected from the group consisting of potassium polyacrylate, sodium polyacrylate, and an acrylic acid-sulfonic acid copolymer salt.

The polyacrylic acid salt may be sodium polyacrylate.

The acrylic acid-maleic acid copolymer salt may have a molecular weight of 5000 or less.

The acrylic acid-maleic acid copolymer salt may be sodium acrylic acid-maleic acid copolymer.

An ink set according to an embodiment of the present disclosure includes: the cleaning solution; and an ink, the ink having a redispersibility index of 0.90 or more.

### DETAILED DESCRIPTION OF THE EXEMPLARY EMBODIMENTS

An embodiment of the present disclosure will be described below.

### First Embodiment: Cleaning Solution

### Overall Configuration

A cleaning solution according to a first embodiment of the present disclosure will be described below. The cleaning solution according to this embodiment includes: a water-soluble organic solvent; a cleaning agent; water; and a surfactant.

First, a formation process of a dried ink that is a target of clearing by the cleaning solution according to this embodiment will be described.

In the case of forming an image using an inkjet recording device, an inkjet recording ink (hereinafter, referred to simply as “ink”) is ejected from the ejection surface of a recording head onto a recording medium. Specifically, the ink is ejected toward the recording medium from a plurality of ejection ports formed in the ejection surface. At this time, the ejected ink adheres to the ejection surface in some cases. When the ink adheres to the ejection surface, the adhered ink comes into contact with air and dries. In this way, the dried ink is formed.

Such a dried ink is particularly likely to be formed in the case where an ink having excellent fixability to recording media with low ink absorption (low absorption media) is used. This is because such an ink contains a relatively large amount of binder resin.

The dried ink can cause an ink ejection failure. This is because the dried ink blocks the ejection port depending on the position where the dried ink is formed. Specifically, when the dried ink blocks part or all of the ejection port, ink is difficult to eject and ink is ejected in a direction different from a desired ejection direction.

When an ink ejection failure occurs, the quality of the formed image deteriorates. For this reason, it is desired to remove the dried ink to prevent the ink ejection failure from occurring. However, with the existing cleaning solution, it has been difficult to remove particularly the dried product of ink containing a binder resin.

On the other hand, the cleaning solution according to this embodiment includes, as a cleaning agent, a polyacrylic acid salt and an acrylic acid-maleic acid copolymer salt. Further, the mass ratio of the acrylic acid-maleic acid copolymer salt to the polyacrylic acid salt is 1 or more and 4 or less.

By including a polyacrylic acid salt as a cleaning agent, the cleaning solution is quickly adsorbed on the dried ink. In order to remove the dried ink, the cleaning solution needs to be adsorbed on the dried ink and undergoes a chemical reaction with the dried ink to dissolve the dried ink. That is, the cleaning solution exhibits its cleaning effect by, for example, dissolving the dried ink. By including the above polyacrylic acid salt, the cleaning solution according to this embodiment is capable of exhibiting its cleaning effect immediately after being adsorbed on the dried ink. Therefore, when the cleaning solution includes the above polyacrylic acid salt, the effect of being quickly adsorbed on the dried ink to increase the removability of the dried ink can be achieved.

Further, by including an acrylic acid-maleic acid copolymer salt as a cleaning agent, it is possible to exhibit high removability of the dried ink as described below. Although the acrylic acid-maleic acid copolymer salt having a relatively large molecular weight tends to be adsorbed on the dried ink more slowly than the polyacrylic acid salt, it is capable of electrically neutralizing the positively charged dried ink by being adsorbed on the dried ink. This allows the dried ink to be in a state in which it is easily separated from the nozzle plate or the like. The dried ink in such a state can be easily removed by a wipe operation using a rubber blade, or the like. In this way, the high removability of the dried ink of the acrylic acid-maleic acid copolymer salt is exhibited. Therefore, when the cleaning solution includes the above acrylic acid-maleic acid copolymer salt, the effect of making the dried ink be easily separated from the nozzle plate or the like and improving the removability of the dried ink can be achieved.

Further, by setting the mass ratio of the acrylic acid-maleic acid copolymer salt to the polyacrylic acid salt to 1 or more and 4 or less, both salts are capable of exhibiting the above effects in a balanced manner and higher removability of the dried ink due to the synergistic effect of both salts can be achieved.

By including the above cleaning agent, the cleaning solution according to this embodiment is quickly adsorbed on the surface of the dried ink and is capable of easily penetrating into the gap between the ejection surface and the dried ink. For this reason, the cleaning solution according to this embodiment causes the dried ink, particularly the portion near the interface between the ejection surface and the dried ink, to swell and dissolve. As a result, the dried ink is peeled off from the ejection surface and is easily removed.

The cleaning solution according to this embodiment has high removability described above and is effective particularly for removing the dried product of ink having excellent fixability to low absorption media, or the like. That is, according to the cleaning solution according to this embodiment, it is possible to safely and efficiently remove the dried product of ink that contains a large amount of binder resin and is difficult to dissolve or disperse.

Note that the cleaning solution disclosed in Japanese Patent No. 6780618 has had a problem of low cleaning performance against the above ink containing a binder resin. On the other hand, by including an appropriate amount of an appropriate cleaning agent, the cleaning solution according to this embodiment is capable of efficiently removing the dried product of ink containing a binder resin.

As described above, the cleaning solution according to this embodiment is capable of suitably removing the dried ink. However, the cleaning solution according to this embodiment is capable of suitably removing not only the dried ink but also undried ink. Therefore, according to the present disclosure, it is possible to provide a cleaning solution capable of efficiently removing the dried product of ink containing a binder resin and an ink set including the cleaning solution.

Next, respective components constituting the cleaning solution according to this embodiment will be described.

### Water-Soluble Organic Solvent

Examples of the water-soluble organic solvent included in the cleaning solution according to this embodiment include a glycol compound, a glycol ether compound, a lactam compound, a nitrogen-containing compound, an acetate compound, thiodiglycol, glycerin, and dimethyl sulfoxide.

Examples of the glycol compound include ethylene glycol, 1,3-propanediol, propylene glycol, 1,2-pentanediol, 1,5-pentanediol, 1,2-octanediol, 1,8-octanediol, 3-methyl-1,3-butanediol, 3-methyl-1,5-pentanediol, diethylene glycol, triethylene glycol, and tetraethylene glycol.

As the water-soluble organic solvent, a glycol compound is favorable and 1,3-propanediol is more favorable.

The content of the water-soluble organic solvent in the cleaning solution according to this embodiment is favorably 5 mass % or more and 70 mass % or less with respect to the total mass of the cleaning solution, more favorably 10 mass % or more and 65 mass % or less.

Note that the type and content of the water-soluble organic solvent are not limited to the above type and content and can be appropriately changed in accordance with the desired viscosity in the cleaning solution, or the like.

### Cleaning Agent

The cleaning agent included in the cleaning solution according to this embodiment include a polyacrylic acid salt and an acrylic acid-maleic acid copolymer salt.

### Polyacrylic Acid Salt

The polyacrylic acid salt is selected from the group consisting of potassium polyacrylate, sodium polyacrylate, and an acrylic acid-sulfonic acid copolymer salt. As the polyacrylic acid salt, sodium polyacrylate is more favorable.

The molecular weight of the polyacrylic acid salt is favorably 10000 or less and more favorably 4000 or less. When the molecular weight of the polyacrylic acid salt is within this range, the cleaning solution including the polyacrylic acid salt is quickly adsorbed on the dried ink and it is favorable from the viewpoint of the removability of the dried ink. The molecular weight is measured using for example, gel permeation chromatography.

The content of the polyacrylic acid salt in the cleaning solution according to this embodiment is favorably 0.02 mass % or more and 1 mass % or less with respect to the total mass of the cleaning solution, more favorably 0.04 mass % or more and 1 mass % or less.

### Acrylic Acid-Maleic Acid Copolymer Salt

As the acrylic acid-maleic acid copolymer salt, sodium acrylic acid-maleic acid copolymer is favorable.

The mass ratio of the acrylic acid-maleic acid copolymer salt to the polyacrylic acid salt is 1 or more and 4 or less. The mass ratio of the acrylic acid-maleic acid copolymer salt to the polyacrylic acid salt is favorably 2 or more and 4 or less, more favorably 2 or more and 3 or less. When the mass ratio of the acrylic acid-maleic acid copolymer salt to the polyacrylic acid salt is less than 1, it is not favorable from the viewpoint of the removability of the dried ink. Meanwhile, in the case where the mass ratio of the acrylic acid-maleic acid copolymer salt to the polyacrylic acid salt exceeds 4, the synergistic effect of both salts cannot be achieved and it is not favorable from the viewpoint of the removability of the dried ink.

The molecular weight of the acrylic acid-maleic acid copolymer salt is favorably 10000 or less, more favorably 5000 or less. When the molecular weight of the acrylic acid-maleic acid copolymer salt is in this range, the performance of the cleaning solution including the acrylic acid-maleic acid copolymer salt to dissolve the dried ink is improved and it is favorable from the viewpoint of the removability of the dried ink.

The content of the acrylic acid-maleic acid copolymer salt in the cleaning solution according to this embodiment is favorably 0.02 mass % or more and 1 mass % or less, more favorably 0.04 mass % or more and 1 mass % or less.

By including the above cleaning agent, the cleaning solution according to this embodiment is quickly adsorbed on the dried ink and has high dissolubility for the dried ink, and therefore it is possible to safely and efficiently remove the dried product of ink that contains a large amount of binder resin and is difficult to dissolve or disperse.

### Surfactant

Examples of the surfactant included in the cleaning solution according to this embodiment include a cationic surfactant, an anionic surfactant, a zwitterionic surfactant, and a nonionic surfactant. As the surfactant, the nonionic surfactant is favorable.

The content of the surfactant in the cleaning solution according to this embodiment is favorably 0.1 mass % or more and 5 mass % or less with respect to the total mass of the cleaning solution, more favorably 0.3 mass % or more and 5 mass % or less.

Note that as the surfactant, only one type of surfactant may be used or two or more types of surfactants may be mixed and used.

### Water

Examples of the water included in the cleaning solution according to this embodiment include commercially available purified water and ion exchanged water. As the water, ion exchanged water is more favorable.

The content of the water is favorably 20 mass % or more and 99 mass % or less with respect to the total mass of the cleaning solution, more favorably 35 mass % or more and 99 mass % or less. When the content of the water is in this range, for example, the viscosity of the cleaning solution including the water can be made suitable for removing the dried ink.

Note that the content of the water included in the cleaning solution according to this embodiment is not limited to the above content and can be appropriately changed in accordance with the desired viscosity in the cleaning solution, or the like.

### Others

The cleaning solution according to this embodiment may further include, as necessary, known additives (e.g., a solubility stabilizer, an anti-drying agent, an antioxidant, a viscosity adjustor, a pH adjuster, and an antifungal agent).

(Physical properties of cleaning solution)

Next, the physical properties of the cleaning solution according to this embodiment will be described.

### Static Surface Tension

The cleaning solution according to this embodiment has a static surface tension of less than 30 mN/m. Specifically, the static surface tension of the cleaning solution at 25° C. is favorably 22 mN/m or more and 30 mN/m or less, more favorably 22 mN/m or more and 25 mN/m or less. When the static surface tension of the cleaning solution is in this range, the wettability of the cleaning solution increases and the cleaning solution quickly penetrates into the gap between the ink and the nozzle plate, or the like, which is favorable from the viewpoint of the removability of the dried ink.

### Viscosity and pH

The viscosity of the cleaning solution according to this embodiment is not particularly limited but is favorably 1mPa·s or more and 10 mPa·s or less, more favorably 1 mPa·s or more and 4 mPa·s or less. Further, the pH of the cleaning solution according to this embodiment is not particularly limited but is favorably 7 or more and 14 or less, more favorably 9 or more and 10 or less, considering the balance between chemical damage to the inkjet head and cleaning performance.

### Method of Removing Dried Ink

The method of removing the dried ink using the cleaning solution according to this embodiment is not particularly limited. However, for example, the dried ink is removed as follows.

First, the cleaning solution according to this embodiment is supplied to the ejection surface of the recoding head to which the dried ink adheres. Examples of the method of supplying the cleaning solution to the ejection surface include supplying with a sponge or a sheet impregnated with the cleaning solution, ejecting the cleaning solution by an ink jet method, applying the cleaning solution using a roller, and spraying the cleaning solution. After that, a wipe operation is performed on the ejection surface using a wiping blade or the like. In this way, the dried ink adhering to the ejection surface can be easily removed.

Note that the cleaning solution according to this embodiment can also be used to remove the dried ink adhering to the member included in the inkjet recording device other than the recoding head.

### Second Embodiment: Ink Set

An ink set according to a second embodiment of the present disclosure will be described below. The ink set according to this embodiment includes: a cleaning solution: and an ink. The cleaning solution and the ink are housed in different containers, for example.

As the cleaning solution included in the ink set according to this embodiment, the cleaning solution according to the first embodiment is used. For this reason, description of the cleaning solution included in the ink set according to this embodiment will be omitted.

The ink included in the ink set according to this embodiment will be described below. The ink is an inkjet recording ink that is used to form an image using an inkjet recording device and has low redispersibility. The low redispersibility means that, for example, when the above ink is applied to the dried product of the above ink, the dried product of the above ink is difficult to redisperse in the above ink. Specifically, the above ink has the redispersibility index of 0.90 or more. The redispersibility index of the above ink is favorably 0.50 or more, more favorably 0.90 or more. When the redispersibility index is in this range, it is difficult to remove, when the ink adheres to the ejection surface or the like of the recoding head and dries, the formed dried ink using the existing cleaning solution.

The redispersibility index of ink is defined as follows. First, a mass A of the plate on which the ink is applied is measured. Next, 200 μl of ink is applied to the plate and spin-coated for 3 seconds at 2000 rpm to form an ink thin film. The formed ink thin film is dried in a constant temperature bath at 40° C. for 3 days, and a total mass B of the dried ink thin film and the above plate is measured. Next, 200 μl of the same type of ink is applied to the obtained ink thin film and allowed to stand in an environment of normal temperature and humidity for 5 minutes. After that, the applied ink is gently removed with approximately 50 ml of ion exchanged water or the like. In the case where the redispersibility of ink is high, the redispersed ink has also been removed at this time. After that, the ink thin film remaining on the plate is allowed to stand in a constant temperature bath at 40° C. for 1 day and a total mass C of the ink thin film and the plate is measured. The value of the ratio ((C−A)/(B−A)) of the value obtained by subtracting the mass A from the mass C to the value obtained by subtracting the mass A from the mass B is defined as the redispersibility index of ink.

It is difficult to remove the dried product of such an ink having a high redispersibility index (ink that is difficult to redisperse) using the existing cleaning solution. On the other hand, the cleaning solution according to this embodiment has high removability for the above ink having a high redispersibility index. Note that the cleaning solution according to this embodiment also has a high removability for ink having a low redispersibility index (ink that is easy to redisperse).

### Other Embodiments

Although embodiments of the present disclosure have been described above, it goes without saying that the present disclosure is not limited to only the above-mentioned embodiments and various modifications can be made.

### Examples and Comparative Examples

Although Examples of the present disclosure will be described below, the present disclosure is not limited to these Examples.

### Preparation of Cleaning Solution

In each of Examples and Comparative Examples, the materials listed in Table 1 were put in a beaker in the blend amounts listed in Table 1. The mixture in the beaker was stirred at a rotational speed of 400 rpm for 30 minutes using a stirrer (“Three-One Motor BL-600” manufactured by Shinto Scientific Co., Ltd.) to prepare the cleaning solution according to each of Examples and Comparative Examples.

TABLE 1

| | | Example | | | Comparative Example | | | | | | |
|---|---|---|---|---|---|---|---|---|---|---|---|
| | | 1 | 2 | 3 | | 2 | 3 | 4 | 5 | 6 | 7 |
| Water-soluble | 1,3-propanediol | 60.8 | 60.8 | 60.8 | 60.8 | 60.8 | 60.8 | 60.8 | 30 | 60.8 | 60.8 |
| organic solvent | Triethylene glycol | 0 | 0 | 0 | 0 | 0 | 0 | 0 | 10 | 0 | 0 |
| | monobutyl ether | | | | | | | | | | |
| | 2-pyrrolidone | 0 | 0 | 0 | 0 | 0 | 0 | 0 | 10 | 0 | 0 |
| Cleaning | Sodium polyacrylate | 0.04 | 0.07 | 0.028 | 0.14 | 0 | 0.1 | 0.04 | 0 | 0.075 | 0.026 |
| agent | (average molecular | | | | | | | | | | |
| | weight = 3500) | | | | | | | | | | |
| | Sodium acrylic acid - | 0.1 | 0.07 | 0.112 | 0 | 0.14 | 0.04 | 0.1 | 0 | 0.065 | 0.114 |
| | maleic acid copolymer | | | | | | | | | | |
| | (average molecular | | | | | | | | | | |
| | weight = 5000) | | | | | | | | | | |
| Surfactant | SILFACE SAG503A | 0.3 | 0.3 | 0.3 | 0.3 | 0.3 | 0.3 | 0 | 0 | 0.3 | 0.3 |
| | Coconut oil fatty acid | 0 | 0 | 0 | 0 | 0 | 0 | 0 | 1 | 0 | 0 |
| | amidopropyl betaine | | | | | | | | | | |
| Basic | 1N sodium | 0 | 0 | 0 | 0 | 0 | 0 | 0 | 0.1 | 0 | 0 |
| compound | hydroxide solution | | | | | | | | | | |
| Deliquescent | Compound represented | 0 | 0 | 0 | 0 | 0 | 0 | 0 | 2 | 0 | 0 |
| material | by formula (1) | | | | | | | | | | |
| Water | Ion-exchanged water | 38.76 | 38.76 | 38.76 | 38.76 | 38.76 | 38.76 | 39.06 | 46.9 | 38.76 | 38.76 |

| | | | | | | | | | | |
|---|---|---|---|---|---|---|---|---|---|---|
| Ratio of sodium acrylic acid - | 2.5 | 1 | 4 | 0 | — | 0.4 | 2.5 | — | 0.87 | 4.38 |
| maleic acid copolymer | | | | | | | | | | |
| to Sodium polyacrylate | | | | | | | | | | |
| Surface tension at 25° C. (mN/m) | 22 | 22 | 22 | 22 | 22 | 22 | 55 | 32 | 22 | 22 |
| Removal ratio (%) | 60 | 50 | 40 | 10 | 20 | 20 | 0 | 0 | 30 | 30 |

As shown in Table 1, in the cleaning solutions according to Examples 1 to 3, the mass ratio of sodium acrylic acid-maleic acid copolymer to sodium polyacrylate is within the range of 1 or more and 4 or less.

Comparative Example 1 is different from Example 1 in that no sodium acrylic acid-maleic acid copolymer is included. Note that the mass percentage of sodium polyacrylate is increased by the mass percentage of sodium acrylic acid-maleic acid copolymer in Example 1 (0.1 mass %).

Comparative Example 2 is different from Example 1 in that no sodium polyacrylate is included. Note that the mass percentage of sodium acrylic acid-maleic acid copolymer is increased by the mass percentage of sodium polyacrylate in Example 1 (0.1 mass %).

In Comparative Example 3, the mass percentage of sodium polyacrylate and the mass percentage of sodium acrylic acid-maleic acid copolymer are reversed compared to those in Example 1. As a result, the mass ratio of sodium acrylic acid-maleic acid copolymer to sodium polyacrylate is 0.4, which is outside the range of 1 or more and 4 or less.

Comparative Example 4 is different from Example 1 in that no surfactant is included. Note that the mass percentage of ion exchanged water is increased by the mass percentage of the surfactant in Example 1 (0.3 mass %).

Comparative Example 5 is different from Example 1 in that neither sodium polyacrylate nor sodium acrylic acid-maleic acid copolymer is included. Note that in Comparative Example 5, 1 N sodium hydroxide solution: 0.1 mass parts as a basic compound and a compound represented by the following formula (1): 2 mass parts as a deliquescent material are included.

The compound represented by the formula (1) included in the cleaning solution according to Comparative Example 5 is as follows.

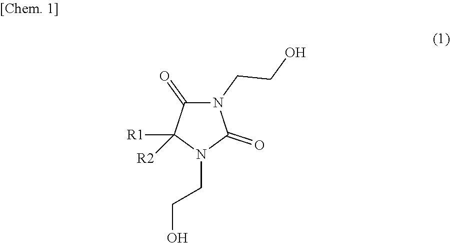

(in the formula (1), R1 and R2 each represent hydrogen, a methyl group, or an ethyl group, the sum of the numbers of carbon atoms of R1 and R2 is 2 or less, and the case where both R1 and R2 represent a methyl group is excluded.)

In Comparative Example 6, the mass percentage of sodium polyacrylate is larger than that in Example 1, and the mass percentage of sodium acrylic acid-maleic acid copolymer is less than that in Example 1 by the same mass percentage (0.035 mass %). As a result, the mass ratio of sodium acrylic acid-maleic acid copolymer to sodium polyacrylate is 0.87, which is outside the range of 1 or more and 4 or less.

In Comparative Example 7, the mass percentage of sodium polyacrylate is less than that in Example 1, and the mass percentage of sodium acrylic acid-maleic acid copolymer is larger than that in Example 1 by the same mass percentage (0.014 mass %). As a result, the mass ratio of sodium acrylic acid-maleic acid copolymer to sodium polyacrylate is 4.38, which is outside the range of 1 or more and 4 or less.

### Preparation of Dried Ink

Using Truepress ink SC+ (SC+ink) BLK00 manufactured by SCREEN Graphic Solutions Co., Ltd., a plurality of ink droplets with a diameter of 20 um was adhered to the nozzle plate of an inkjet head KJ4B-1200 manufactured by KYOCERA Document Solutions Inc. The adhered ink droplet was dried in an environment of a temperature of 35° C. and a humidity of 15% for 72 hours, the dried ink was prepared.

### Method of Evaluating Ink Removability of Cleaning Solution

In each of Examples and Comparative Examples, 0.1 ml of the cleaning solution was added dropwise onto a region of the thin stainless steel plate in the inkjet head where no ink droplet is adhered, using a pipettor. A wipe operation was performed twice at 20 second intervals on the above inkjet head using a rubber blade. The line pressure was 10 N/m, and the wiping speed was kept constant at 30 mm/s.

The ink removability of each cleaning solution was evaluated on the basis of the removal ratio of the ink droplet. The removal ratio was defined as the ratio of the number of ink droplets removed by the wipe operation to the number of the formed ink droplets, in the portion where the rubber blade comes into contact during the wipe operation.

### Measurement of Static Surface Tension

The static surface tension of each cleaning solution was measured using a surface tensiometer (“automatic surface tensiometer DY-300” manufactured by Kyowa Interface Science Co., Ltd.) in accordance with the Wilhelmy method (plate method). In all of Examples 1 to 3, the static surface tension at 25° C. was 22 and was within the range of less than 30.

### Measurement of Molecular Weight

The molecular weight of the used sodium polyacrylate was measured using gel permeation chromatography and found to be 3500, which was within the range of 4000 or less. Similarly, the molecular weight of sodium acrylic acid-maleic acid copolymer was measured and found to be 5000, which was within the range of 5000 or less.

### Evaluation of Examples and Comparative Examples

As shown in Table 1, the cleaning solutions according to Example 1 to Example 3 each exhibited a high removal ratio of 40% to 60%. This is presumably because the mass ratio of sodium acrylic acid-maleic acid copolymer to sodium polyacrylate was within the range of 1 or more and 4 or less and thus the higher removability of the dried ink due to the synergistic effect of both salts could be achieved.

As shown in Table 1, the cleaning solution according to Comparative Example 1 had a low removal ratio of 10%. This is presumably because no sodium acrylic acid-maleic acid copolymer was included and thus the effect of electrically neutralizing the dried ink to allow the dried ink to be in a state in which it is easily separated from the nozzle plate could not be achieved.

As shown in Table 1, the cleaning solution according to Comparative Example 2 had a low removal ratio of 20%. This is presumably because no sodium polyacrylate was included and thus the effect of being quickly adsorbed on the dried ink to improve the removability of the dried ink could not be achieved.

As shown in Table 1, the cleaning solution according to Comparative Example 3 had a low removal ratio of 20%. This is presumably because the mass ratio of sodium acrylic acid-maleic acid copolymer to sodium polyacrylate was less than 1, the synergistic effect of both salts could not be exhibited, and a sufficient removability of the dried ink could not be achieved.

As shown in Table 1, the cleaning solution according to Comparative Example 4 had a low removal ratio of 0%. This is presumably because no surfactant was included, the wettability was kept high, it could not sufficiently penetrate into the gap between the dried ink and the nozzle plate or the like, and a sufficient removability of the dried ink could not be achieved.

As shown in Table 1, the cleaning solution according to Comparative Example 5 had a low removal ratio of 0%. This is presumably because neither sodium polyacrylate nor sodium acrylic acid-maleic acid copolymer was included and thus the effect of being quickly adsorbed on the dried ink to improve the removability of the dried ink and the effect of electrically neutralizing the dried ink to allow the dried ink to be in a state in which it is easily separated from the nozzle plate could not be achieved.

As shown in Table 1, the cleaning solution according to Comparative Example 6 had a slightly low removal ratio of 30%. This is presumably because the mass ratio of sodium acrylic acid-maleic acid copolymer to sodium polyacrylate is less than 1, the synergistic effect of both salts could not be exhibited, and a sufficient removability of the dried ink could not be achieved.

As shown in Table 1, the cleaning solution according to Comparative Example 7 had a slightly low removal ratio of 30%. This is presumably because the mass ratio of sodium acrylic acid-maleic acid copolymer to sodium polyacrylate exceeded 4, the synergistic effect of both salts could not be exhibited, and a sufficient removability of the dried ink could not be achieved.

### Evaluation of Redispersibility of Ink

The redispersibility of the ink was evaluated as follows. First, the mass A of a SUS304 plate cut into 3 cm squares was measured. Next, 200 μl of the ink was applied to the SUS304 plate whose mass had been measured and spin-coated for 3 seconds at 2000 rpm to form an ink thin film. The formed ink thin film was dried in a constant temperature bath at 40° C. for 3 days, and the total mass B of the dried ink thin film and the above SUS304 plate was measured. Next, 200 μl of the same type of ink was applied to the obtained ink thin film and allowed to stand in an environment of normal temperature and humidity for 5 minutes. After that, the applied ink was gently removed with approximately 50 ml of ion exchanged water. After that, the ink thin film remaining on the SUS304 plate was allowed to stand in a constant temperature bath at 40° C. for 1 day and the total mass C of the ink thin film and the SUS304 plate was measured. The redispersibility index of the ink was calculated using the following formula (1). The calculated redispersibility index of the ink is shown in Table 2.

$$Redispersibility index = ( C - A ) / ( B - A ) \qquad ( 1 )$$

TABLE 2

| | Mass A | | | (C − A) / |
|---|---|---|---|---|
| | (g) | Mass B (g) | Mass C (g) | (B − A) |
| Truepress ink SC+ | 0.3562 | 0.3577 | 0.3577 | 1.0 |
| (SC+ ink) BLK00 | | | | |

From the results shown in Table 2, it can be seen that the cleaning solution according to each Example also has a high removability for the ink having a low redispersibility (high redispersibility index).

It should be understood by those skilled in the art that various modifications, combinations, sub-combinations and alterations may occur depending on design requirements and other factors insofar as they are within the scope of the appended claims or the equivalents thereof.

What is claimed is:

1. A cleaning solution, comprising:
a water-soluble organic solvent;
a polyacrylic acid salt;
an acrylic acid-maleic acid copolymer salt;
water; and
a surfactant,
a mass ratio of the acrylic acid-maleic acid copolymer salt to the polyacrylic acid salt being 1 or more and 4 or less.

2. The cleaning solution according to claim 1, which has a static surface tension of less than 30 mN/m.

3. The cleaning solution according to claim 1, wherein
the polyacrylic acid salt has a molecular weight of 4000 or less.

4. The cleaning solution according to claim 3, wherein
the polyacrylic acid salt is selected from the group consisting of potassium polyacrylate, sodium polyacrylate, and an acrylic acid-sulfonic acid copolymer salt.

5. The cleaning solution according to claim 4, wherein
the polyacrylic acid salt is sodium polyacrylate.

6. The cleaning solution according to claim 1, wherein
the acrylic acid-maleic acid copolymer salt has a molecular weight of 5000 or less.

7. The cleaning solution according to claim 6, wherein
the acrylic acid-maleic acid copolymer salt is sodium acrylic acid-maleic acid copolymer.

8. An ink set, comprising:
the cleaning solution according to claim 1; and
an ink,
the ink having a redispersibility index of 0.90 or more.
